(19) United States
(12) Patent Application Publication
(10) Pub. No.: US 2010/0054515 A1
(43) Pub. Date: Mar. 4, 2010

(54) MICROPHONE

(75) Inventors: Herbert Donauer, Wedemark (DE); Rene Crain, Xanten (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/549,815

(22) Filed: Aug. 28, 2009

(30) Foreign Application Priority Data
Sep. 1, 2008 (DE) 10 2008 045 112.6

(51) Int. Cl. H04R 11/04

(52) U.S. Cl. 381/355

(57) ABSTRACT

There is provided a microphone (1) having a microphone housing (2) and an adaptor ring (4). The adaptor ring serves for connecting a first circular end of a microphone head (5) and a first non-circular end of the microphone housing (2).

The invention concerns a microphone, a battery unit for a microphone, a process for the production of a microphone housing, a pocket transmitter and a receiver for wireless communication with the pocket transmitter.

Wireless and wired microphones, in particular vocal microphones, are known from stage technology. Such microphones have an (electroacoustic) sound transducer for converting sound into a corresponding electrical signal, the microphone signal. In the case of a wireless vocal microphone the microphone signal is wirelessly transmitted by way of an antenna to a remote receiver. In that case it is possible to use digital or analog transmission methods. The microphone signal received at the receiver can be passed for example to a mixing desk which is operated by a sound technician.

In general a wireless microphone has a microphone head and a microphone housing. The microphone housing serves to hold the microphone in the hand and when the microphone is being held the person can sing or speak in the direction of the microphone head. Disposed in the microphone housing is an antenna, by way of which the microphone signal is emitted to a receiver. The signal recorded or acquired by the sound transducer is passed prior to transmission by way of the antenna to a signal processing unit and amplifier unit. The voltage supply required for operation of the microphone is provided by way of a battery or an accumulator.

Wireless vocal microphones generally have a cylindrical housing which is of a round cross-section and which narrows towards one end. The microphone head is frequently spherical or cylindrical and is also of a round cross-section.

The object of the present invention is to provide a microphone which has improved handling and enhanced flexibility. A further or alternative object is to provide a production process for a microphone according to the invention, in particular for the microphone housing, which allows inexpensive and flexible production.

That object is attained by a microphone as set forth in claims 1 and 6 and by a process as set forth in claim 10.

Thus there is provided a microphone having a microphone housing and an adaptor ring. The adaptor ring serves for connecting a first circular end of a microphone head and a first non-circular end of the microphone housing. A non-circular cross-section of the microphone housing permits a more flexible arrangement of structural units disposed in the housing. The structural units include for example an antenna, a battery pack, a signal processing unit and parts of a sound transducer. An external non-circular shape for the housing can also determine the orientation of the microphone in the hand.

In accordance with an aspect of the present invention the first end of the microphone housing is in cross-section in the form of an overstretched rectangle.

In accordance with a further aspect of the present invention the microphone head is releasably connected to the adaptor ring. In that way the microphone head can possibly be interchanged.

In accordance with a further aspect of the present invention the microphone housing has a microphone housing grip which can be pulled off the microphone housing.

In accordance with a further aspect of the present invention the microphone housing has a display, an LED for displaying the operating condition of the microphone and/or a device for operating a microphone menu.

The invention also concerns a microphone comprising a microphone housing and a battery receiving unit for receiving a battery unit. In that case the battery unit has an antenna receiving unit. When the battery unit is received in the battery receiving unit, the antenna is then also received in the antenna receiving unit. The antenna enjoys additional mechanical protection after insertion of the battery unit. Furthermore the degree of freedom in terms of arranging an antenna on the microphone housing is enhanced.

The invention also concerns a battery unit for a microphone, wherein the battery unit has a receiving unit for an antenna.

The invention also concerns a process for the production of a microphone housing for a microphone, wherein the process comprises the steps: placing a tube in a tool mold which is of the external shape of the microphone housing and closing the tube ends with punches; feeding a medium into the interior of the tube through one of the punches to produce an internal pressure in the tube, which allows deformation of the tube. That process makes it possible to achieve a complex geometry for a microphone housing in production at a high level of quality, for example a low reject rate or a high level of breaking strength of the material after deformation.

In accordance with a further aspect of the invention a pocket transmitter for wireless communication with a receiver has a top side and a front side. A microphone connection and an antenna connection are arranged on the top side. An LED for operational display of the pocket transmitter is arranged in the region of the transition between the front side and the top side. Lighting of the LED is perceptible when viewing the top side and/or the front side so that only one LED has to be used to permit the lit-up LED to be perceived from the specified various directions.

In accordance with a further aspect of the present invention a receiver for wireless communication with a pocket transmitter is of a parallelepipedic shape and has a fastening device for fastening to a rack. The front side and/or the rear side of the parallelepipedic receiver have cooling fins or cooling ribs.

Further configurations of the invention are subject-matter of the appendant claims.

The embodiments by way of example and advantages of the present invention are described more fully hereinafter with reference to the accompanying drawings.

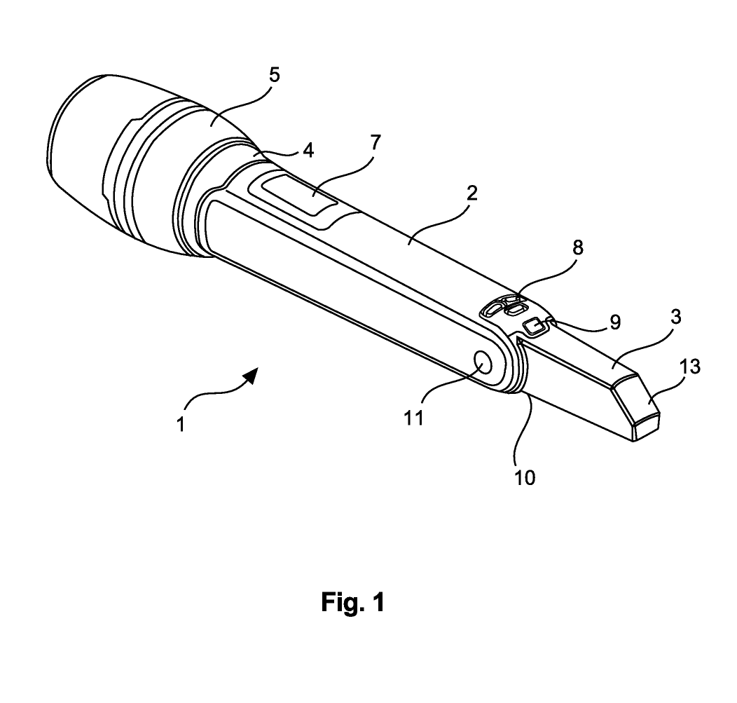

FIG. 1 shows a perspective view of a microphone according to a first embodiment,

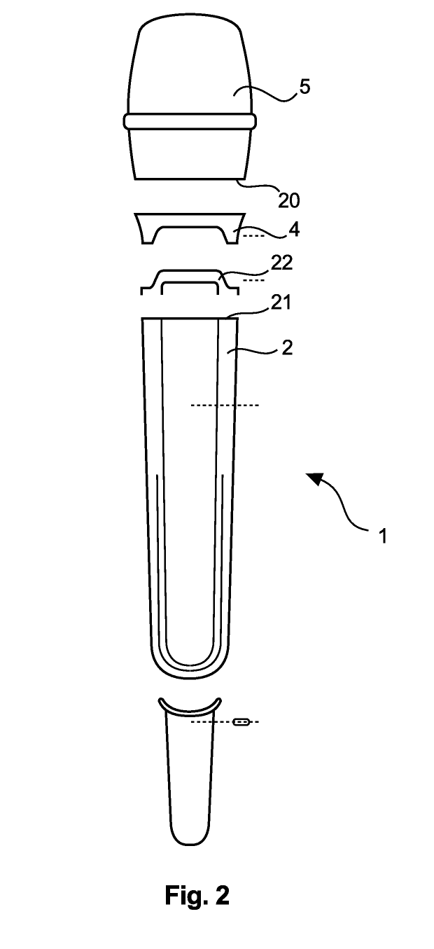

FIG. 2 shows an exploded plan view of a microphone according to a second embodiment,

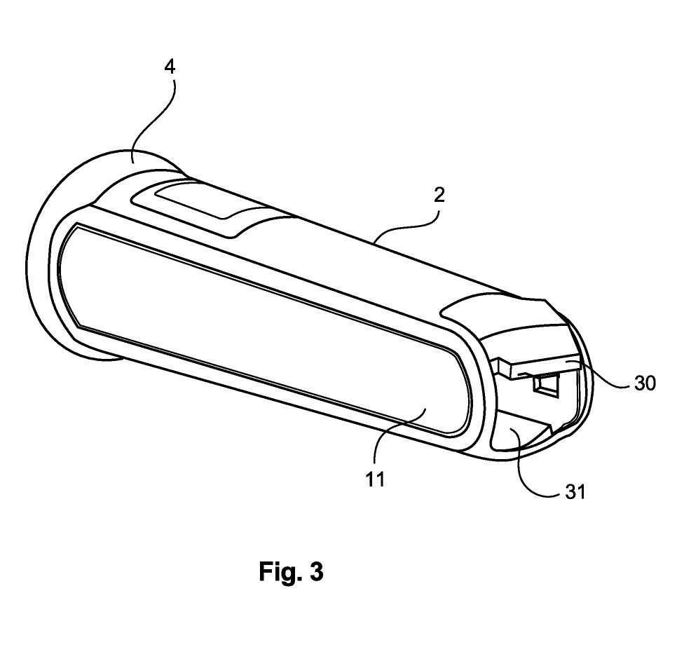

FIG. 3 shows a perspective view of a microphone housing according to a third embodiment,

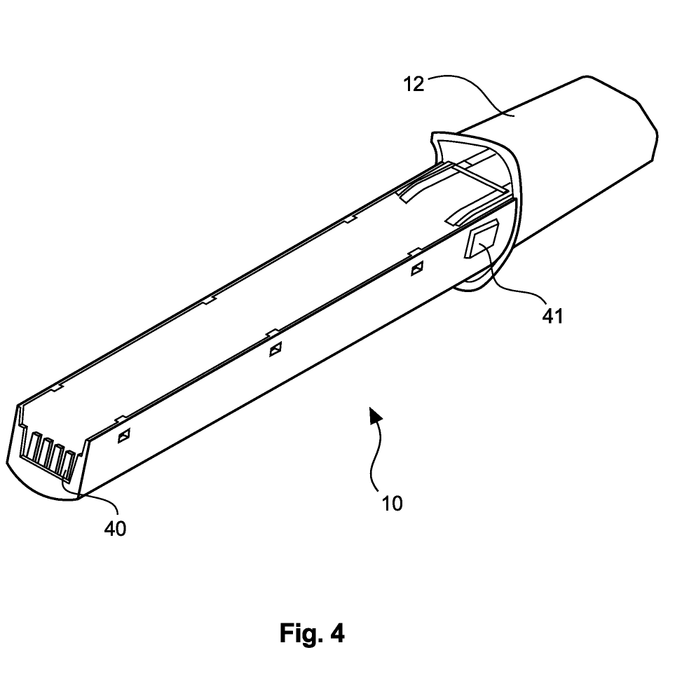

FIG. 4 shows a perspective view of an accumulator unit for a microphone according to a fourth embodiment,

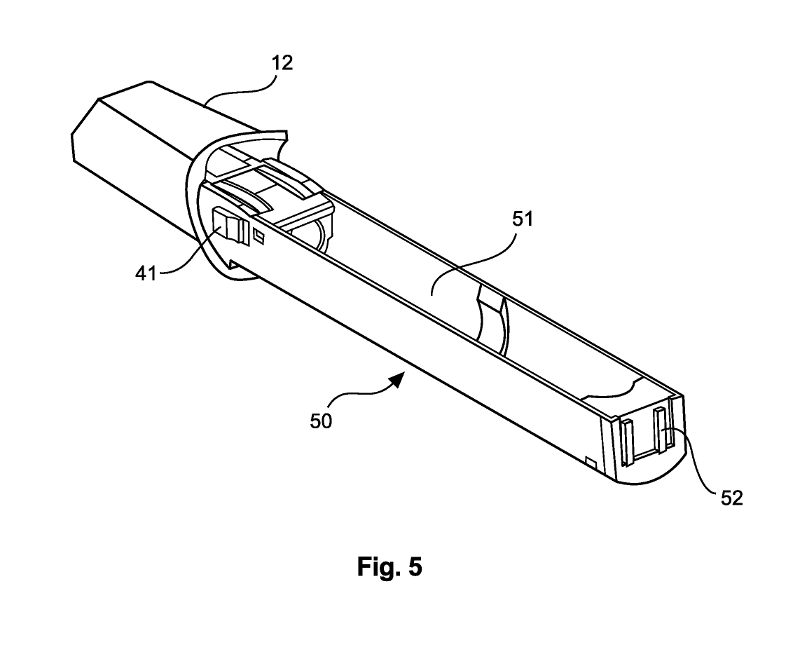

FIG. 5 shows a perspective view of a battery unit for a microphone according to a fifth embodiment,

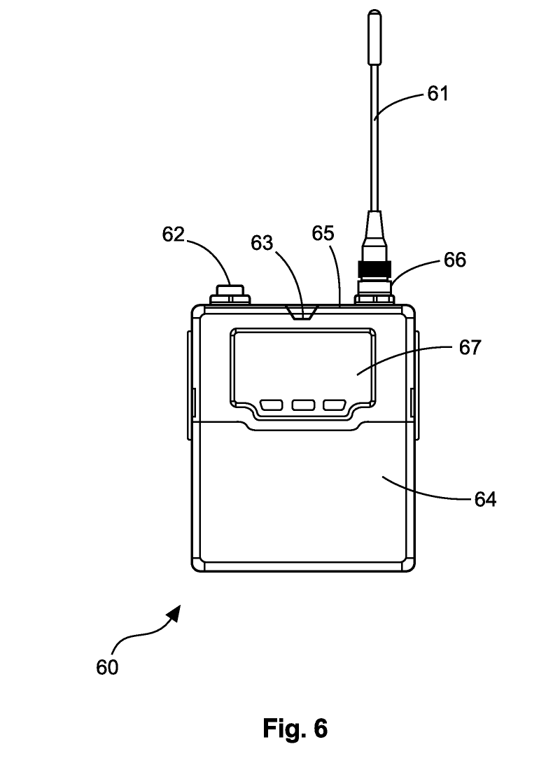

FIG. 6 shows a plan view of a pocket transmitter according to a sixth embodiment,

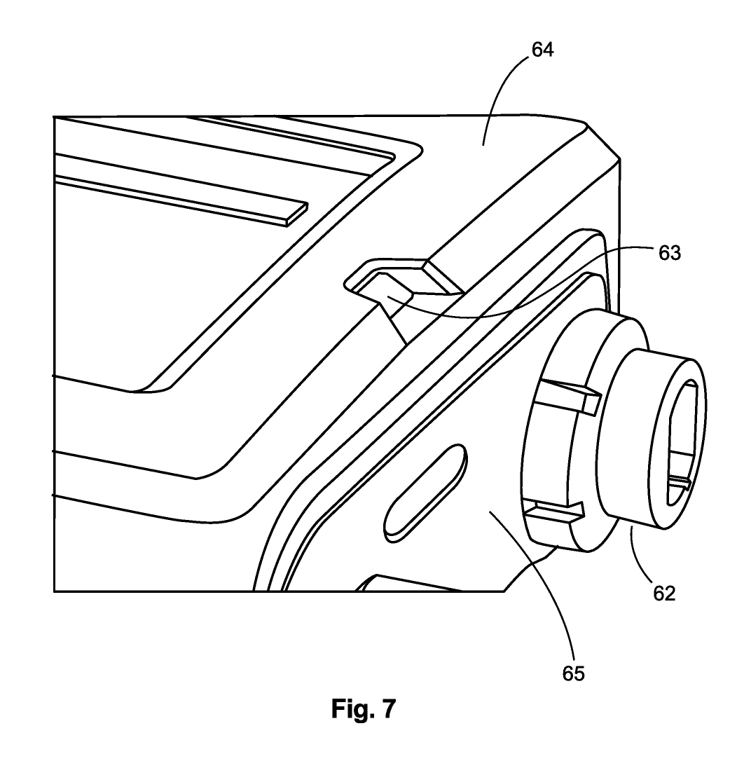

FIG. 7 shows a perspective view of a portion of a pocket transmitter as shown in FIG. 6,

FIG. 8 shows a perspective view of a receiver according to a seventh embodiment,

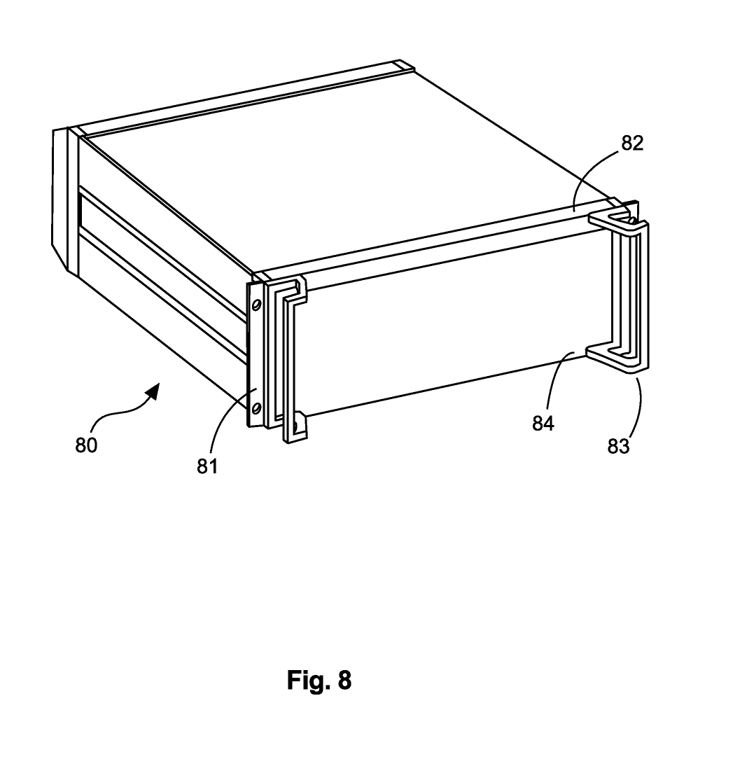

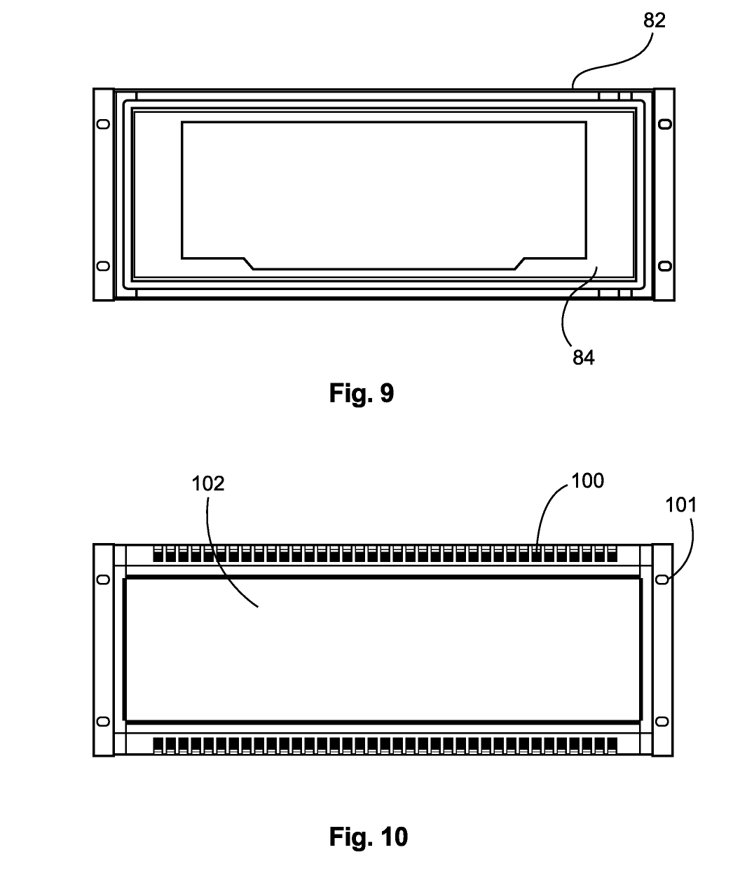

FIG. 9 shows a front view of the receiver of FIG. 8,

FIG. 10 shows a rear view of the receiver of FIG. 8,

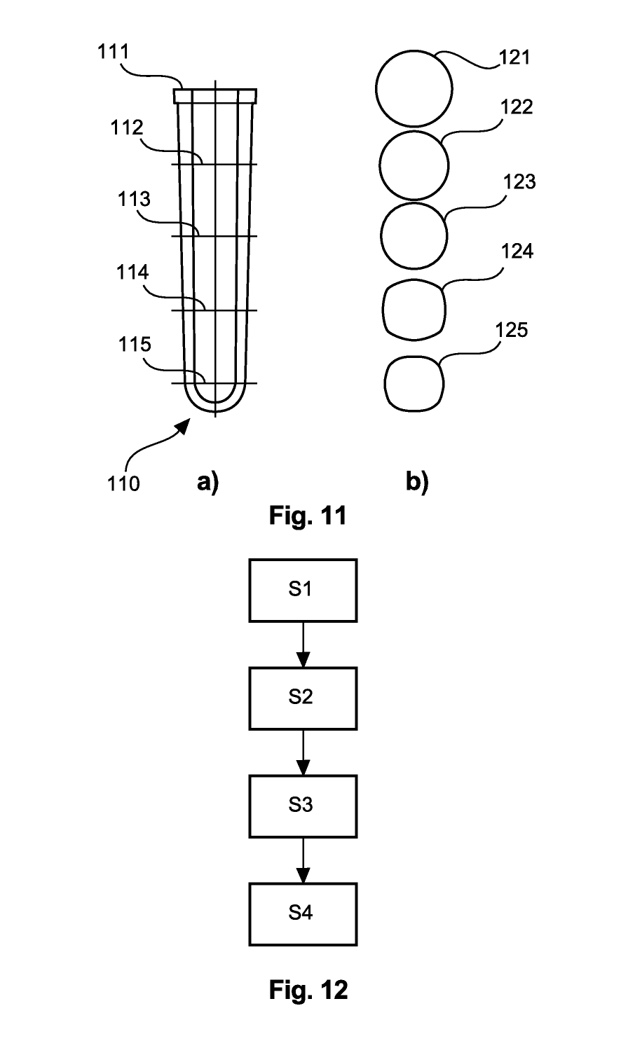

FIG. 11 shows a cross-sectional configuration of the microphone housing according to an eighth embodiment, and

FIG. 12 shows a flow chart of a production process for a microphone housing according to a ninth embodiment.

FIG. 1 shows a perspective view of a microphone according to a first embodiment. The microphone 1 has a microphone housing 2 and a microphone head 5. The microphone head 5 is of a circular cross-section. The microphone housing 2 has an at least partially non-circular cross-section, for example in the form of an overstretched rectangle or square. The microphone head 5 is connected to the microphone housing 2 by way of an (optionally removable) adaptor ring 4. The adaptor ring 4 consequently connects a non-circular cross-section of the microphone housing 2, here a cross-section in the form of an overstretched rectangle, to a circular cross-section of the microphone head 5. The microphone head 5 can be releasably connected to the adaptor ring 4, for example by way of a screw connection. Therefore a plurality of microphone heads can be connected to the microphone housing 2 by way of the adaptor ring 4, that is to say the microphone heads are interchangeable and accordingly various microphone heads can be fastened to the microphone housing 2. The microphone housing 2 further has a display 7 as well as knobs 8 for operation of a microphone menu or for working through a menu of the microphone 1. An LED 9 shows the operating condition of the microphone 1. An antenna 3 of the microphone 1 is disposed in a receiving unit 13 for the antenna 3. The receiving unit 13 is connected to a battery unit 10 and is pushed into and arrested in a receiving unit for the battery unit, which is disposed in the microphone housing 2. The arresting action can be released by actuation of the knobs 11 so that the battery unit can also be removed again. The cross-section of an overstretched square of the microphone housing 2 makes it possible to accommodate elements disposed in the housing, in a compact space-saving fashion, such as for example a part of the battery unit, an antenna connection, a signal processing unit for receiving a microphone signal and for producing an antenna signal which is emitted by the antenna 3.

FIG. 2 shows an exploded plan view of the microphone 1 in accordance with a second embodiment. The microphone head 5 has a first circular end 20. That is connected to the housing 2 by way of the (optionally removable) adaptor ring 4. A first end 21 of the microphone housing 2 is in the shape of an overstretched rectangle in cross-section. Arranged at the first end 21 of the microphone housing is a stirrup 22 which is connected to the adaptor ring 4.

FIG. 3 shows a perspective view of a microphone according to a third embodiment. The microphone housing 2 is shown without the antenna 3 and without the battery unit 10. The adaptor ring 4 is connected (optionally removably) to the housing 2 and the housing 2 has a connection 30 for an antenna. The receiving unit 31 serves to receive the battery unit 10. The knobs 11 serve for arresting and releasing the battery unit 10.

The microphone housing 2 can also have a microphone housing grip or handle which in particular fits together in positively locking relationship with the microphone housing, wherein the microphone housing grip is removable from the microphone housing and can be pushed thereonto. Such a configuration provides that the operating elements (knobs for menu control) are protected from mechanical loading and/or incorrect operation. A microphone housing which is closed in that way also avoids solid-borne sound. Operating elements can be exposed by pulling off the microphone grip and adjustment of the microphone is then possible. That operating condition can be described as the technician mode. In a stage mode the microphone housing grip is pushed on to the microphone housing so that incorrect operations are out of the question.

FIG. 4 shows a perspective view of an accumulator unit for a microphone according to a fourth embodiment. The battery unit 10 can be in the form of an accumulator pack. Disposed at the front side of the battery unit are (electrical) contact locations 40. The battery unit 10 also has two oppositely disposed noses 41 which serve for securing the battery unit to the microphone housing 2. The battery unit 10 has a receiving unit 12 for the antenna. The antenna is generally connected to the antenna connection 30 of the microphone housing 2 in FIG. 3. When the battery unit 10 is introduced into the microphone housing 2 the antenna receiving unit 12 of the battery unit 10 receives the antenna which is connected to the connection 30. That provides additional mechanical protection for the antenna.

FIG. 5 shows a perspective view of a battery unit for a microphone according to a fifth embodiment. Unlike the battery unit 10 of FIG. 4 the battery unit 50 does not have an accumulator pack, but individual batteries can be inserted into a compartment 51 provided for receiving the batteries. Contact locations 52 are disposed at the end of the battery unit 50. The noses 41 serve to secure the battery unit 50 to the microphone housing 2 in FIG. 3. The battery unit 50 of FIG. 5, exactly like the battery unit 10 of FIG. 4, has an antenna receiving unit 12. An antenna is received with the antenna receiving unit 12 and is mechanically protected thereby.

FIG. 6 shows a plan view of a pocket transmitter 60 according to a sixth embodiment. Arranged at a top side 65 of the pocket transmitter is a microphone connection 62 and an antenna connection 66 to which an antenna 61 is connected. A display 67 is provided on a front side 64 of the pocket transmitter 60. An LED 63 is arranged inclinedly in the region of the transition between the front side and the top side. Accordingly, lighting of the LED 63 can be perceived both from the front and also from above, that is to say when viewing the front side and when viewing the top side respectively. The pocket transmitter can be secured for example by a clip to a belt of a person. A microphone is then fixed in the proximity of the mouth of a person and connected to the microphone connection 62 by way of a cable. The signal recorded by the microphone is then wirelessly transmitted by way of the antenna 61.

FIG. 7 shows a portion of the pocket transmitter 60 of FIG. 6. The LED 63 is disposed inclinedly in the transitional region between the front side 64 and the top side 65.

FIG. 8 shows a perspective view of a receiver 80 according to a seventh embodiment. The receiver 80 has a fastening device 81 for fastening the receiver 80 to a rack. The receiver 80 can be pushed into and withdrawn from the rack by means of handles 83. Fins for cooling purposes or cooling ribs 84 are arranged at the front side 82 of the receiver 80.

FIG. 9 shows the front side 82 of the receiver 80 of FIG. 8. The cooling ribs 84 extend parallel to the upper edge of the front side.

FIG. 10 shows a rear view of the receiver 80 of FIG. 8. A rear side 102 of the receiver 80 can also optionally have cooling fins or cooling ribs 100. The bores 101 serve for fastening the receiver to a rack.

FIG. 11 shows a cross-sectional configuration of a microphone housing 110 according to an eighth embodiment. FIG. 11a shows a plan view of the microphone housing 10. Five section lines 111, 112, 113, 114 and 115 are shown in this plan view. FIG. 11b shows the cross-sections at those section lines viewed from above. The corresponding cross-sections from the top downwardly are represented by references 121, 122, 123, 124, 125 in FIG. 11b. The cross-section 125 describes an overstretched square. The cross-section 121 corresponds to a circle. The cross-sections 122, 123 and 124 therebetween uniformly convert the overstretched square into a circle.

FIG. 12 shows a flow chart of a process for the production of a microphone housing according to a ninth embodiment. A tube is produced in an extrusion process (S1). A tube is placed in a tool mold which is of the external shape of the microphone housing (S2). The tube ends are closed by punches (S3). A medium, for example water, is introduced into the tube interior through one of the punches to produce an internal pressure therein, which allows shaping of the tube (S4). After the tube has been placed in the tool mold, with the two punches, a pressure medium, for example water, is introduced into the internal space in the tube through one of the punches. The tube is shaped to correspond to the tool mold, by the pressure in the tube. In that shaping operation it can happen that the tube material between the punches is not sufficient for shaping deformation. In that case the punches can advance tube material inwardly. It is particularly preferable for the tube to comprise an anodisable alloy. The non-circular geometry of a microphone housing according to the invention can be anodised in many colors. If a corresponding microphone housing were produced in a conventional casting process anodisation would not be possible. The illustrated process makes it possible to achieve the comparatively complicated geometry of the microphone housing with simultaneous anodisability of the microphone housing.

1. A microphone comprising:
a microphone housing having a first non-circular end,
a microphone head having a first circular end, and
an adaptor ring for connecting the first circular end of a microphone head and the first end of the microphone housing.

2. A microphone as set forth in claim 1 wherein the first end of the microphone housing is in cross-section in the form of an overstretched rectangle.

3. A microphone as set forth in claim 1 wherein the microphone head is releasably connected to the adaptor ring.

4. A microphone as set forth in claim 1 comprising a microphone housing grip which can be pulled off the microphone housing and can be pushed on to the microphone housing.

5. A microphone as set forth in claim 1 wherein the microphone housing has a display, an LED for displaying the operating condition of the microphone and/or a device for operating a microphone menu.

6. A microphone comprising:
a microphone housing,
a battery receiving unit for receiving a battery unit, wherein the battery unit has an antenna receiving unit, wherein the antenna is received in the antenna receiving unit when the battery unit is received in the battery receiving unit.

7. A microphone as set forth in claim 6 comprising a releasable arresting device for releasing and arresting the battery unit on the microphone housing.

8. A microphone as set forth in claim 6 comprising a communication device for wireless radio communication, the communication device having at least one antenna.

9. A battery unit for a microphone, in particular as set forth in claim 1, comprising a receiving unit for an antenna.

10. A process for the production of a microphone housing for a microphone, comprising the steps:
producing a tube in an extrusion process;
placing the tube in a tool mold which is of the external shape of the microphone housing and closing the tube ends with punches; and
feeding a medium into the tube interior through one of the punches for producing an internal pressure in the tube which allows deformation of the tube.

11. A process as set forth in claim 10 wherein the tube comprises an anodisable alloy.

12. A pocket transmitter for wireless communication with a receiver, comprising
a top side and a front side, and
an LED for operational display of the pocket transmitter, which is arranged inclinedly in the region of the transition between the front side and the top side,
wherein the top side has a microphone connection and an antenna connection.

13. A receiver for wireless communication with a pocket transmitter, in particular as set forth in claim 12, wherein
the receiver is parallelepipedic and has a fastening device for fastening to a rack, wherein
the receiver has a front side and a rear side in opposite relationship to the front side, wherein
the front side and/or the rear side have cooling fins or cooling ribs.
